(19) United States
(12) Patent Application Publication
(10) Pub. No.: US 2003/0040456 A1
(43) Pub. Date: Feb. 27, 2003

(54) Method and apparatus for cleaning article

(76) Inventors: Tetsuo Imai, Tokiyama-shi Yamaguchi (JP); Masaaki Nakashima, Tokuyama-shi Yamaguchi (JP)

Correspondence Address: BIRCH STEWART KOLASCH & BIRCH, PO BOX 747, FALLS CHURCH, VA, 22040-0747, US

(21) Appl. No.: 10/149,134

(22) PCT Filed: Oct. 11, 2001
(86) PCT No.: PCT/JP01/08928

(30) Foreign Application Priority Data
Oct. 13, 2000 (JP) 2000-313768

(51) Int. Cl. B08B 3/04; C11D 17/00

(52) U.S. Cl. 510/417; 134/26; 134/61; 510/506

(57) ABSTRACT

A method of cleaning an article having oil adhered thereto, which enables the article to be cleaned easily in a short period of time and provides a high degree of cleanliness to the article.

The article having oil adhered thereto is pre-cleaned with an oil dissolving detergent comprising at least one organic solvent having high compatibility with oil such as a propylene glycol alkyl ether and then cleaned with an oil peeling detergent in which at least one organic solvent which is identical to the above organic solvent contained in the oil dissolving detergent and water form a homogeneousphase or emulsion phase.

### FIELD OF THE INVENTION

The present invention relates to a method of cleaning articles, which is suitable for removing oils and fats adhered to metal parts and the like, and stains such as a flux and fingerprint on electronic parts and the like, and to a cleaning system for use in the method.

### DESCRIPTION OF THE PRIOR ART

Oil exemplified by processed oils such as a press oil, heat treated oil and rolling oil and fatty oils such as a flux and fingerprint is adhered to metal parts, electronic parts, semiconductor parts and the like during their production processes and use. To clean articles having such oil adhered thereto, a Freon-based solvent or halogen-based solvent has been used because they are incombustible and have no risk of ignition and excellent cleanability. The above solvents are now being replaced by an aqueous detergent containing a surfactant and an alkali as essential ingredients; organic solvent-based detergent comprising an organic solvent such as a hydrocarbon or alcohol; or semi-aqueous detergent which is an emulsion prepared by dispersing a hydrocarbon in water using a surfactant or an aqueous solution of a polar organic solvent, under the apprehension of the destruction of the global environment and influence upon the human body.

However, these freon-based and halogen-based solvent substitutional detergents still have problems to be solved. The aqueous detergent has such problems as high foamability, insufficient cleanability and disposal of a large amount of waste water.

Since the organic solvent-based detergent has high compatibility with an oil stain, it can dissolve oil adhered to an article to clean it. However, when it is used continuously, the concentration of the oil dissolved in the detergent becomes high and the oil is adhered to the article again. Therefore, multiple rinsing tanks must be installed after multiple cleaning tanks and the detergent must be always regenerated by distillation to reduce the concentration of the dissolved oil to a low level in order to achieve a high degree of cleanliness.

When the organic solvent is a hydrocarbon-based organic solvent, it is a dangerous object classified under the category of type II petroleum or type III petroleum according to the Fire Services Act. Therefore, the amount of the organic solvent in stock and the amount of a detergent to be used are restricted. Consequently, a complicated and expensive explosion-proof device such as a vacuum distillation device must be installed and the cost of equipment becomes high when the cleaning tank is large in size.

Further, since the semi-aqueous detergent contains water, its oil solubility is low, it has no problems such as the re-adhesion of oil or the regeneration by distillation of the agent as seen in the above organic solvent-based detergent, and does not require the installation of the above explosion-proof device as it is incombustible. However, it is much inferior to the organic solvent-based detergent in cleanability. That is, cleaning of an article with the semi-aqueous detergent is carried out by modifying or dissolving oil at the oil adhesion interface to peel the oil from the article and separating the surfacing or settling oil by an oil-water separation device. However, the peeling of the oil proceeds very slow and if a high degree of cleanliness is to be achieved, a long cleaning time is required.

U.S. Pat. No. 5,610,132 discloses a semi-aqueous detergent which comprises water, propylene glycol having high compatibility with water and propylene glycol hardly soluble in water.

### SUMMARY OF THE INVENTION

It is therefore an object of the present invention to provide a method of cleaning an article having oil adhered thereto, which enables the article to be cleaned easily in a short period of time and provides a high degree of cleanliness to the article.

It is another object of the present invention to provide a method of cleaning an article by combining an oil dissolving detergent which is an organic solvent-based detergent and an oil peeling detergent which is a semi-aqueous detergent in a specific form.

It is still another object of the present invention to provide a cleaning system for carrying out the cleaning method of the present invention.

Other objects and advantages of the present invention will become apparent from the following description.

According to the present invention, firstly, the above objects and advantages of the present invention are attained by a method of cleaning an article, comprising the steps of:

(1) cleaning the article having oil adhered thereto with a first detergent which comprises at least one organic solvent having high compatibility with oil; and

(2) cleaning the article from the step (1) with a second detergent in which at least one organic solvent and water form a homogeneousphase or emulsion phase, the second detergent comprising at least one organic solvent which is identical to the organic solvent having high compatibility with oil contained in the first detergent.

According to the present invention, secondly, the above objects and advantages of the present invention are attained by a multi-tank cleaning system comprising a pre-cleaning tank containing a first detergent which comprises at least one organic solvent having high compatibility with oil and a post-cleaning tank containing a second detergent in which water and at least one organic solvent identical to the at least one organic solvent contained in the first detergent form a homogeneousphase or emulsion phase, both tanks being directly connected to each other.

### BRIEF DESCRIPTION OF THE ACCOMPANYING DRAWINGS

FIG. 1 is a schematic diagram of a typical example of a multi-tank cleaning system used in the cleaning method of the present invention; and

FIG. 2 is a phase diagram of propylene glycol monobutyl ether, dipropylene glycol monomethyl ether and water.

### DETAILED DESCRIPTION OF THE PREFERRED EMBODIMENT

In the present invention, the organic solvent having high compatibility with oil is an organic solvent having high compatibility with oil adhered to an article to be cleaned, preferably an organic solvent which can be mixed with castor oil (Japanese Pharmacopoeia Act) as a typical example of the oil and standard oil in any ratio at 30° C. Preferred examples of the organic solvent having high compatibility with such oil include paraffin-based hydrocarbons such as dodecane, undecane and tridecane, naphthene-based hydrocarbons and polar organic solvents. Out of these, polar organic solvents are preferred. The polar organic solvents are preferably organic solvents having a dielectric constant of 8 or more, preferably 10 or more, such as glycol ether-based compounds, pyrrolidone-based compounds and imidazolidinone-based compounds. As the glycol ether-based compounds may be used ethylene glycol-based compounds but preferred are propylene glycol alkyl ether-based compounds.

In the cleaning method of the present invention, the article having oil adhered thereto is first pre-cleaned with a first detergent which is an oil dissolving detergent comprising at least one organic solvent having high compatibility with oil.

The organic solvent having high compatibility with oil is preferably a polar organic solvent as described above because excellent cleanability can be obtained. The polar organic solvent is particularly preferably an organic solvent having low compatibility with water, specifically solubility in water at 60° C. of 50 vol % or less, preferably 30 vol % or less. More specifically, the polar organic solvent is preferably selected from a propylene glycol alkyl ether-based compound represented by the following formula (I):

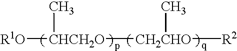

wherein R¹ and R² are each independently a hydrogen atom or alkyl group having 1 to 4 carbon atoms, and p and q are each independently an integer of 0 to 3, with the proviso that p+q=1 to 3, R¹ and R² cannot be a hydrogen atom at the same time, when one of R¹ and R² is a hydrogen atom, the other is an alkyl group having 3 or more carbon atoms, and when R¹ and R² are both a methyl group or ethyl group, p+q=2 to 3,

a pyrrolidone-based compound represented by the following formula (IV):

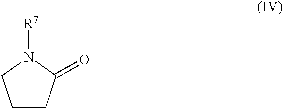

wherein R⁷ is an alkyl group having 7 to 10 carbon atoms; and an imidazolidinone-based compound represented by the following formula (V):

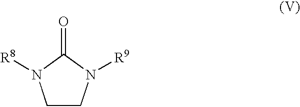

wherein R⁸ and R⁹ are each independently an alkyl group having 3 to 5 carbon atoms.

Out of these, a propylene glycol alkyl ether-based compound represented by the general formula (I) is particularly preferred.

In the above formula (I), the alkyl group having 1 to 4 carbon atoms represented by R¹and R²may be linear or branched. Specific examples of the alkyl group include methyl group, ethyl group, propyl group, isopropyl group, butyl group, isobutyl group, sec-butyl group and tert-butyl group. Illustrative examples of the propylene glycol alkyl ether-based compound represented by the formula (I) include propylene glycol monopropyl ether, propylene glycol monobutyl ether, dipropylene glycol monobutyl ether, dipropylene glycol monopropyl ether, tripropylene glycol monobutyl ether, dipropylene glycol dimethyl ether, tripropylene glycol dimethyl ether, dipropylene glycol diethyl ether, dipropylene glycol dibutyl ether, propylene glycol monoisopropyl ether, and tripropylene glycol tert-butyl ether. Out of these, propylene glycol monobutyl ether and dipropylene glycol monopropyl ether are particularly preferred.

In the formula (IV), the alkyl group having 7 to 10 carbon atoms represented by R⁷ may be linear or branched, as exemplified by heptyl group, octyl group, nonyl group, decyl group and 3-ethylhexyl group. Illustrative examples of the pyrrolidone compound represented by the formula (IV) include N-heptylpyrrolidone, N-octylpyrrolidone, N-(3-ethylhexyl) pyrrolidone and N-decylpyrrolidone. Out of these, N-octylpyrrolidone is particularly preferred.

Further, in the formula (V), the alkyl group having 3 to 5 carbon atoms represented by R⁸ and R⁹ may be linear or branched, as exemplified by propyl group, isopropyl group, butyl group, isobutyl group, sec-butyl group and tert-butylpentyl group. Illustrative examples of the imidazolidinone compound represented by the formula (V) include 1,3-dipropyl-2-imidazolidinone, 1,3-diisopropyl-2-imidazolidinone, 1-propyl-3-butyl-2-imidazolidinone, 1,3-dibutyl-2-imidazolidinone and 1,3-dipentyl-2-imidazolidinone. Out of these, 1,3-dipropyl-2-imidazolidinone and 1,3-diisopropyl-2-imidazolidinone are particularly preferred.

In the present invention, the first detergent may be a mixture of a polar organic solvent having high compatibility with oil and low compatibility with water and a polar organic solvent having high compatibility with oil and high compatibility with water or a mixture of a polar organic solvent having high compatibility with oil and low compatibility with water and a surfactant. The polar organic solvent having high compatibility with oil and high compatibility with water and the surfactant may be the same as those to be described for the second detergent hereinafter.

In the present invention, the first detergent may contain a small amount of another organic solvent as an optional component if it retains high compatibility with oil. The first detergent may contain, for example, a lower alcohol such as ethanol, methanol or isopropyl alcohol, or a lower ketone such as acetone in an amount that does not impair its compatibility with oil, preferably 20 vol % or less.

The first detergent may also contain additives such as an inorganic alkali component, rust-proof component and surfactant in small amounts.

Most of the oil firmly adhered to the article is quickly dissolved by pre-cleaning with the first detergent. Oil remaining on the surface of the article turns to a state where it can be easily peeled in a short period of time as the adhesion interface of the oil is modified or an easily soluble portion of the oil is dissolved. Further, the adhesion of oil re-adhered as a component dissolved in the detergent to the surface of the article is weakened. Therefore, by carrying out pre-cleaning and then cleaning with the second detergent which is an oil peeling detergent to be described hereinafter, the oil adhered to the above article can be removed easily at a high degree of cleanliness.

The above pre-cleaning may be carried out by any known cleaning method, for example, one in which the article to be cleaned is immersed in a cleaning tank containing the first detergent or one in which the article is sprayed with the detergent. In general, the method in which the article is immersed in the cleaning tank is preferred. In this case, it is preferred to carry out the immersion of the article until adhered oil is completely removed. However, since the oil remaining on the surface turns to a state where it can be easily peeled in a short period of time as described above and can be easily removed in the subsequent step of cleaning with the second detergent in the present invention, a remarkable cleaning effect is obtained by carrying out the above pre-cleaning to such an extent that the adhered oil is roughly removed. In general, the article to be cleaned is preferably immersed at a fluid temperature of 10 to 40° C. for 1 minute or more, preferably 2 to 5 minutes.

As for the above immersion, the article may be simply immersed in the cleaning fluid as it is and special physical force does not need to be applied to the fluid from the viewpoint of simplifying the device. When cleanability is yet to be further improved in the above step, ultrasonic waves, stirring or vibration may be applied to the cleaning fluid.

According to the present invention, as the above pre-cleaning may be carried out to such an extent that the adhered oil is roughly removed, the pre-cleaning tank may be small in size and an explosion-proof device attached to the above pre-cleaning tank may be small in size as well though the first detergent is classified under the category of second petroleum or third petroleum according to the Fire Services Act. In general, the capacity of the pre-cleaning tank is ½ to 1/20, preferably ⅓ to 1/15 the capacity of the post-cleaning tank.

In the present invention, the oil re-adhered to the surface of the article by pre-cleaning turns to such a state where it can be easily removed with the second detergent in the subsequent step. Since this function is exhibited well even if a considerably amount of oil is dissolved in the first detergent, the above pre-cleaning may be carried out on a large number of articles with the same fluid until the concentration of the oil in the fluid becomes considerably high. In general, cleaning can be carried out until the concentration of the oil in the fluid becomes 60% by mass, preferably40% by mass. Generally speaking, when a new fluid equivalent to the amount of the cleaning fluid brought to the outside of the tank together with the cleaned article is supplied to the pre-cleaning tank, the concentration of the oil dissolved in the cleaning fluid in the tank is maintained at 30 to 50% by mass in most cases. Therefore, in this case, the operation of distillation/regeneration which is generally carried out on the cleaning fluid when cleaning is carried out with the first detergent can be omitted. The amount of the first detergent equal to the amount brought to the outside together with the article may be supplied, thereby making it possible to considerably reduce the amount of the first detergent used.

In the present invention, the article to be pre-cleaned with the first detergent is cleaned with a second detergent which contains at least one organic solvent identical to the organic solvent having high compatibility with oil contained in the first detergent and in which the organic solvent and water form a homogeneousphase or emulsion phase. Since the oil remaining on the article turns to a state where it can be easily peeled by pre-cleaning as described above and the oil re-adhered from the cleaning fluid by pre-cleaning has low adhesion, the oils can be easily peeled by cleaning with the second detergent.

Since the second detergent contains an organic solvent having high compatibility with oil and also water, its compatibility with oil is greatly weakened and its oil solubility is very low. Therefore, as it reaches its oil saturation solubility quickly at the time of cleaning, most of the oil adhered to the article is removed by peeled from the article. The second detergent has a saturation solubility at 60° C. of castor oil (Japanese Pharmacopoeia Act) which is a standard oil of preferably 3 wt % or less, more preferably 1 wt % or less.

Since the second detergent contains a large amount of water, it is generally incombustible. Therefore, cleaning with the second detergent is easy to be manipulated and can be carried out without the need of installing a special explosion-proof device.

It is essential in the present invention that the organic solvent having the above property contained in the above second detergent should be identical to the organic solvent contained in the first detergent. This makes it possible to suppress a great change in the composition of the second detergent caused by the inclusion of a different type of organic solvent which is contained in the first detergent and brought from the pre-cleaning step together with the article and to continue cleaning stably.

When the first detergent contains in combination of two or more organic solvents, at least one of them may be used as an organic solvent contained in the second detergent. However, to carry out the above cleaning stably, organic solvents contained in the second detergent are used in combination of two or more same as the organic solvents contained in the first detergent. In this case, the first detergent and the second detergent are preferably prepared by mixing together two or more organic solvents substantially in the same ratio. Specifically, the ratio of the organic solvents of the second detergent changes from the ratio of the organic solvents of the first detergent by preferably ±15% or less, more preferably ±10% or less, much more preferably 5% or less.

In the present invention, for the above reason, the organic solvent contained in the second detergent is suitably selected from polar organic solvents such as apropylene glycol alkyl ether-based compound, pyrrolidone-based compound represented by the general formula (IV) and imidazolidinone-based compound represented by the general formula (V) like the first detergent. In general, these polar organic solvents have high compatibility with oil but low compatibility with water.

Therefore, since a homogeneousphase is hardly formed when these polar organic solvents are each mixed with water, a compatibilizing agent is preferably used. The compatibilizing agent is preferably a polar organic solvent having high compatibility with oil and high compatibility with water. Although the polar organic solvent having the above property is slightly inferior to the above polar organic solvent having low compatibility with water in compatibility with oil and oil cleanability, it makes the above polar organic solvent having low compatibility with water homogeneous in water and improves the cleanability of the second detergent when it is supplied, according to the type thereof.

Compatibility with water means ability of mixing with water in any ratio at 60° C.

The above polar organic solvent having high compatibility with oil and high compatibility with water is preferably a propylene glycol alkyl ether represented by the following formula (II):

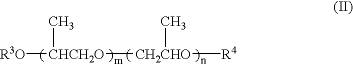

wherein R³and R⁴ are each independently a hydrogen atom, methyl group or ethyl group, and m and n are each independently an integer of 0 to 3, with the proviso that R³ and R⁴ cannot be a hydrogen atom or ethyl group at the same time, when one of R³ and R⁴ is a hydrogen atom, m+n is 1 to 3 and when R³ and R⁴ are both a methyl group, m+n is 1, or an imidazolidinone compound represented by the following formula (III):

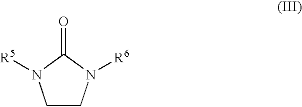

wherein R⁵ and R⁶ are each independently a methyl group or ethyl group.

They may be used alone or in combination of two or more.

Illustrative examples of the propylene glycol alkyl ether-based compound represented by the above formula (II) include propylene glycol monomethyl ether, propylene glycol dimethyl ether, dipropylene glycol monomethyl ether, dipropylene glycol monoethyl ether, tripropylene glycol monomethyl ether and tripropylene glycol monoethyl methyl ether. Out of these, propylene glycol monomethyl ether and dipropylene glycol monomethyl ether are particularly preferred.

Illustrative examples of the imidazolidinone compound represented by the above formula (III) include 1,3-dimethyl-2-imidazolidinone and 1,3-diethyl-2-imidazolidinone. Out of these, 1,3-dimethyl-2-imidazolidinone is particularly preferred.

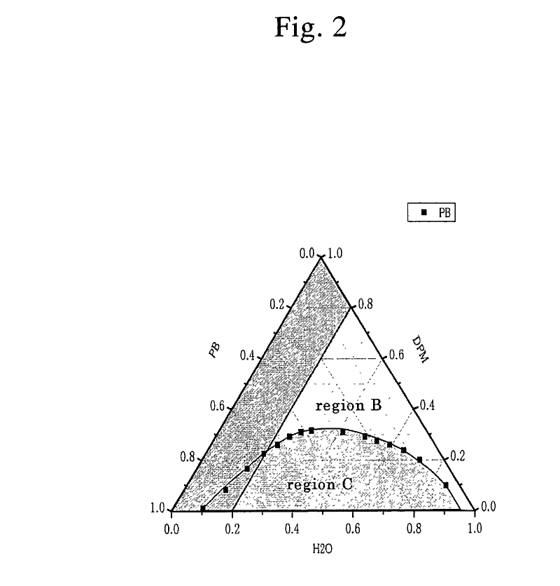

FIG. 2 shows a phase diagram obtained when dipropylene glycol monomethyl ether which is a propylene glycol alkyl ether-based compound represented by the above formula (II) as a compatibilizing agent and propylene glycol monobutyl ether as a polar organic solvent having high compatibility with oil and low compatibility with water were mixed with water at 60° C. The region C is a region where the three components do not dissolve uniformly and two phases, namely an organic solvent phase and a water phase, are formed. The regions A and B are regions where the three components become compatible with one another to form a homogeneousphase. Although a detergent having composition in the above region A or B may be used as the second detergent, a detergent having composition in the region A has a low content of water and flammability. Therefore, a detergent having composition in the region B having no flammability can be preferably used. The phrase “having no flammability” means that a flash point cannot be observed by a Cleveland flash point measurement method (JIS K2265).

In the second detergent, the ratio of the components cannot be determined unconditionally because there is a slight difference in water solubility according to the type of each component. In general, a second detergent containing a polar organic solvent having high compatibility with oil in an amount of 3 to 80 vol %, preferably 10 to 70 vol % and water in an amount of 20 to 97 vol %, preferably 30 to 90 vol % has excellent cleanability and is incombustible advantageously. When the above polar organic solvent having high compatibility with oil and low compatibility with water and polar organic solvent having high compatibility with oil and high compatibility with water are used in combination as polar organic solvents having high compatibility with oil, the volume ratio of the two solvents is preferably 8:2 to 2:8, preferably 7:3 to 3:7.

When the second detergent contains the above polar organic solvent having high compatibility with oil and high compatibility with water as a compatibilizing agent, the first detergent used for pre-cleaning is preferably prepared by mixing together the above polar organic solvent with a polar organic solvent having high compatibility with oil and low compatibility with water in substantially the same ratio as that of the second detergent. In this case, the ratio of the above polar organic solvents is preferably a ratio at which the fluid is not separated into a water phase and an organic solvent phase and is kept uniform (region C in FIG. 2) even when any amount of water is added to a mixture of these solvents in order to carry out the cleaning step with the second detergent stably.

The second detergent in the present invention may contain a surfactant as a compatibilizing agent so that the organic solvent having high compatibility with oil and low compatibility with water and water form an emulsion phase. This is particularly effective when a nonpolar organic solvent such as a paraffin-based hydrocarbon or naphthene-based hydrocarbon having low compatibility with water is used as the above organic solvent.

Any known surfactant is acceptable if the organic solvent having high compatibility with oil and low compatibility with water and water can form a stable emulsion phase. A nonionic surfactant is preferred from the viewpoints of cleanability and the stability of the fluid.

Examples of the nonionic surfactant include higher glycol ethers such as polyoxyethylene alkyl ethers and polyoxyethylene alkylphenyl ethers; surfactants having a sugar chain such as fatty acid cane sugar esters and alkyl polyglycosides; and amine-based surfactants such as fatty acid diethanolamides and higher amine ethylene oxide adducts. Out of these, higher glycol ethers and amine-based surfactants are preferred and polyoxyethylene alkyl ethers and higher amine ethylene oxide adducts are particularly preferred.

The amount of the surfactant is preferably 0.1 to 5 wt %, more preferably 0.5 to 3 wt %.

Even when a surfactant is used as the compatibilizing agent of the second detergent, the first detergent used for pre-cleaning is preferably amixed solution of the same organic solvent and surfactant as those contained in the second detergent. The organic solvent and surfactant contained in the first detergent are preferably used in substantially the same ratio as in the second detergent.

The second detergent may contain another organic solvent, rust-proof agent, antioxidant, inorganic alkali component and the like in small amounts like the first detergent if it retains low compatibility with oil.

For cleaning with the second detergent, any known cleaning method may be employed like cleaning with the first detergent. In general, the method in which the article is immersed in a post-cleaning tank containing the cleaning fluid is preferred. The article to be cleaned is immersed at a fluid temperature of 40 to 70° C. for 1 minute or more, preferably 2 to 5 minutes. During immersion, application of physical force such as ultrasonic waves, stirring or vibration to the fluid is preferred to further improve the cleaning effect.

Further, when a large number of articles are to be cleaned continuously, in order to prevent a reduction in the amount of water contained in the second detergent in the post -cleaning tank by the pre-cleaning fluid brought from the pre-cleaning tank together with the articles, water is supplied into the second detergent from time to time to maintain the content of water at almost a constant value.

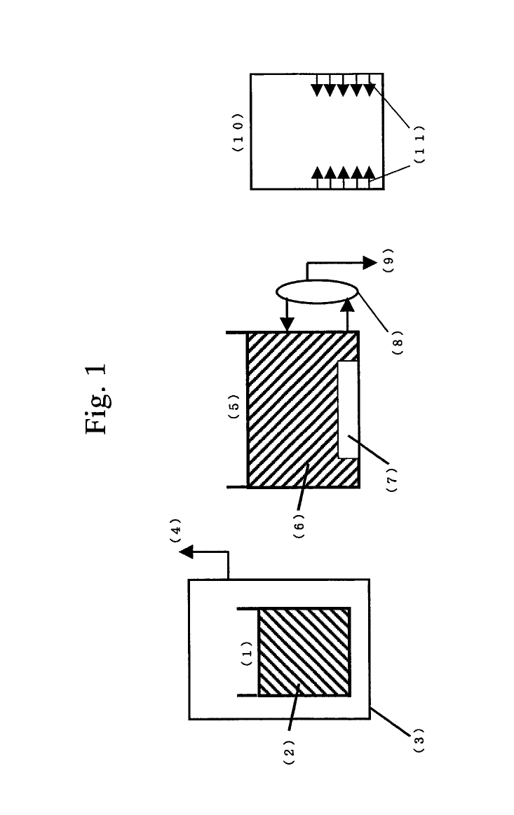

The cleaning method of the present invention using the multi-tank cleaning system of FIG. 1 which is a typical cleaning system used to carry out the method will be described hereinbelow.

In FIG. 1, (1) denotes the pre-cleaning tank which contains the first detergent (2) comprising at least one organic solvent having high compatibility with oil. The pre-cleaning tank (1) may not have a large capacity because oil adhered to the article to be cleaned may be mostly dissolved and removed by immersing the article for a short time and a large amount of oil may be dissolved in the first detergent. Therefore, an explosion-proof device attached to the pre-cleaning tank may be as small as an enclosure (3) connected to a local exhaust device (4).

The article which has been easily pre-cleaned by the above cleaning is transferred to the post-cleaning tank (5) in the subsequent stage. The post-cleaning tank (5) contains the second detergent (6) in which at least one organic solvent identical to the organic solvent contained in the first detergent and water form a homogeneousphase or emulsion phase. Most of the oil adhered to the article is dissolved and removed by the above pre-cleaning and the remainder turns to a state where it can be extremely easily peeled. Further, the oil dissolved in the detergent and re-adhered to the article is easily peeled from the surface of the article by immersion in the second detergent (6) in the post-cleaning tank (5) due to its low adhesion and surfaces or settles. For the immersion of the above article, the post-cleaning tank may be provided with an ultrasonic wave generator (7), stirring blades, vibrator or the like to improve its cleaning effect.

Since the oil (9) removed from the above article is phase separated from the second detergent (6) as floating oil in most cases, the floating oil can be easily separated by an oil-water separation device (8) and removed to the outside of the system. A known oil-water separation device (8) may be used but a coalescer type device is particularly preferred.

The article cleaned in the above post-cleaning tank may be dried with hot air (11) in a hot air drying tank (10). The multi-tank cleaning system shown in FIG. 1 can clean the article at a high degree of surface cleanliness.

Since the first detergent (2) in the above pre-cleaning tank (1) may contain a large amount of oil as described above in the present invention, a plurality of articles may be cleaned continuously. When a large amount of oil is dissolved in the first detergent (2) in the pre-cleaning tank (1) as a result of continuous cleaning, a new cleaning fluid may be exchanged with the old cleaning fluid. In the multi-tank cleaning system, the above pre-cleaning tank and post-cleaning tank are directly connected to each other. A similar cleaning tank may be installed before or after each cleaning tank. For example, one or more cleaning tank containing the second detergent may be installed after the post-cleaning tank to achieve a rinsing effect.

As described above, according to the cleaning method of the present invention, the article having oil adhered thereto can be cleaned at a high degree of cleanliness in a short period of time by a simple method.

Therefore, the above method can be advantageously used as a cleaning method which is effective for various articles having oil adhered thereto, such as metal parts, electronic parts and semiconductor parts.

### EXAMPLES

The following examples are provided for the purpose of further illustrating the present invention but are in no way to be taken as limiting.

The organic solvents and surfactants used in examples and comparative examples are given below.

PB: propylene glycol monobutyl ether (infinitely soluble in castor oil at 30° C., solubility in water at 60° C.: 6 vol %)

DPM: dipropylene glycolmonomethyl ether (infinitely soluble in castor oil at 30° C. and infinitely soluble in water at 60° C.)

DPP: dipropylene glycol monopropyl ether (infinitely soluble in castor oil at 30° C., solubility in water at 60° C.: 10 vol %)

DMI: 1,3-dimethyl-2-imidazolidinone (infinitely soluble in castor oil at 30° C., and infinitely soluble in water at 60° C.)

NMP: N-methylpyrrolidone (infinitely soluble in castor oil at 30° C. and infinitely soluble in water at 60° C.)

TD: n-tetradecane (infinitely soluble in castor oil at 30° C., solubility in water at 60° C.: less than 1 vol %)

NS: coconut amine adduct with 5 mols of ethylene oxide (nonionic surfactant)

### Examples 1 to 8

An article having oil adhered thereto was cleaned by the multi-tank cleaning system shown in FIG. 1. The compositions of the first detergent (3 liters) in the pre-cleaning tank and the second detergent (30 liters) in the post-cleaning tank are shown in Table 1. The post-cleaning tank was provided with an ultrasonic wave generator having an output of 600 W. The post-cleaning tank was also provided with a coalescer type oil-water separator (Eutec of Asahi Chemical Industry Co., Ltd.). As for the temperature of the detergent in each cleaning tank, the temperature of the first detergent was 30° C. and that of the second detergent in the post-cleaning tank was 60° C.

As the article having oil adhered thereto was used an aluminum plate measuring 50 mm×80 mm×1 mm to which commercially available cutting oil (Daphne Cut HS-1 of Idemitsu Kosan Co., Ltd.) was adhered in an amount of about 150 mg/plate. The above article was immersed in the first detergent for 60 seconds and in the second detergent for 120 seconds. The article taken out from the post-cleaning tank was dried at 110° C. for 20 minutes. After drying, the weight of the oil adhered to the article was measured and the removal rate was given as degreasing rate in Table 1.

### Comparative Example 1

Cleaning was carried out in the same manner as in Example 1 except that cleaning in the pre-cleaning tank was not carried out and only cleaning in the post-cleaning tank was carried out for 180 seconds. The degreasing rate is shown in Table 1.

TABLE 1

| | composition of oil | | |
|---|---|---|---|
| | dissolving | composition of oil peeling | degreasing |
| | detergent (vol %) | detergent (vol %) | rate (%) |
| Ex. 1 | PB/DPM = 30/70 | PB/DPM/water = 9/21/70 | 99 |
| Ex. 2 | DPP/DPM = 30/70 | DPP/DPM/water = 9/21/70 | 99 |
| Ex. 3 | DPM = 100 | DPP/DPM/water = 9/21/70 | 99 |
| Ex. 4 | NMP = 100 | NMP/water = 50/50 | 89 |
| Ex. 5 | PB/DMI = 80/20 | PB/DMI/water = 60/15/25 | 100 |
| Ex. 6 | TD/NS = 80/20 | TD/NS/water = 4/1/95 | 98 |
| Ex. 7 | TD = 100 | TD/NS/water = 4/1/95 | 98 |
| Ex. 8 | PB/DPM = 90/1O | PB/DPM/water = 9/21/70 | 99 |
| C. Ex. 1 | nil | PB/DPM/water = 9/21/70 | 45 |

Ex.: Example
C. Ex. Comparative Example
*All of the oil peeling detergents have a linseed oil saturation solubility at 60° C. of 1 wt % or less.

### Examples 9 to 14

8,000 articles were cleaned continuously in the same manner as in Examples 1 to 8. The water content of the oil peeling detergent in the post-cleaning tank was maintained at almost a constant value by supplying water from time to time in order to prevent a reduction in the content of water caused by the first detergent brought together with the articles. The degreasing rate of the final 8,000-th article is shown in Table 2.

After the end of cleaning, the concentration of oil dissolved in the second detergent in the pre-cleaning tank was about 35 wt %.

### Comparative Example 2

8,000 articles were cleaned in the same manner as in Example 9 except that only cleaning in the pre-cleaning tank was carried out for 180 seconds. The degreasing rate of the final 8,000-th article is shown in Table 2.

After the end of cleaning, the concentration of oil dissolved in the first detergent in the pre-cleaning tank was about 35 wt %.

### Comparative Example 3

8,000 articles were cleaned in the same manner as in Example 9 except that the amount of TD of the first detergent used for pre-cleaning was changed to 100%. Since DPM has almost no compatibilizing function for water, TD brought from the pre-cleaning tank together with the articles was phase separated in the post-cleaning tank along with the proceeding of cleaning and removed to the outside of the system by the oil-water separation device. PB contained in the second detergent was extracted into the separation phase of TD, the cleanability of the detergent was reduced, and the degreasing rate of the final 8,000-th article was reduced to 32% as shown in Table 2.

After the end of cleaning, the concentration of oil dissolved in the first detergent in the pre-cleaning tank was about 35 wt %.

TABLE 2

| | composition of oil | | |
|---|---|---|---|
| | dissolving | composition of oil peeling | degreasing |
| | detergent (vol %) | detergent* (vol %) | rate (%) |
| Ex. 9 | PB/DPM = 30/70 | PB/DPM/water = 9/21/70 | 99 |
| Ex. 10 | DPP/DPM = 30/70 | DPP/DPM/water = 9/21/70 | 99 |
| Ex. 11 | DPM = 100 | DPP/DPM/water = 9/21/70 | 76 |
| Ex. 12 | NMP = 100 | NMP/water = 50/50 | 88 |
| Ex. 13 | PB/DMI = 80/20 | PB/DMI/water = 60/15/25 | 100 |
| Ex. 14 | TD/NS = 80/20 | TD/NS/water = 4/1/95 | 98 |
| C. Ex. 2 | PB/DPM = 30/70 | nil | 35 |
| C. Ex. 3 | TD = 100 | PB/DPM/water = 9/21/70 | 32 |

Ex.: Example
C. Ex. Comparative Example
*All of the oil peeling detergents have a linseed oil saturation solubility at 60° C. of 1 wt % or less.

### Example 15

Continuous cleaning was carried out using the system of Example 7 (composition of first detergent (vol %): TD=100, composition of first detergent (vol %): TD/NS/water=4/1/95) in the same manner as in Examples 9 to 14. Before the 2,500-th article was cleaned, the second detergent in the post-cleaning tank formed a uniform emulsion phase and cleaning could be continued at a high degreasing rate of 98 to 99%.

When the number of the articles cleaned exceeded the above value, in the second detergent in the post-cleaning tank, TD brought from the pre-cleaning tank together with the article was phase separated and removed to the outside of the system by the oil-water separator.

### Example 16

Continuous cleaning was carried out using the system of Example 8 (composition of first detergent (vol %): PB/DPM=90/10, composition of first detergent (vol %): PB/DPM/water=9/21/70) in the same manner as in Examples 9 to 14. Before the 1,500-th article was cleaned, the second detergent in the post-cleaning tank formed a homogeneousphase and cleaning could be continued at a high degreasing rate of 99%.

When the number of the articles cleaned exceeded the above value, in the second detergent in the post-cleaning tank, PB brought from the pre-cleaning tank together with the article was phase separated and removed to the outside of the system by the oil-water separator.

1. A method of cleaning an article, comprising the steps of:
(1) cleaning the article having oil adhered thereto with a first detergent which comprises at least one organic solvent having high compatibility with oil; and
(2) cleaning the article from the step (1) with a second detergent in which at least one organic solvent and water form a homogeneousphase or emulsion phase, the second detergent comprising at least one organic solvent which is identical to the organic solvent having high compatibility with oil contained in the first detergent.

2. The method of claim 1, wherein the first detergent is a mixture of a polar organic solvent having high compatibility with oil and low compatibility with water and a polar organic solvent having high compatibility with oil and high compatibility with water, and the second detergent is such that these polar organic solvents and water form a homogeneousphase.

3. The method of claim 2, wherein the ratio of the polar organic solvent having high compatibility with oil and low compatibility with water to the polar organic solvent having high compatibility with oil and high compatibility with water in the second detergent is substantially the same as the ratio of these polar organic solvents in the first detergent.

4. The method of claim 2 or 3, wherein the polar organic solvent having high compatibility with oil and low compatibility with water is a propylene glycol alkyl ether represented by the following formula (I): 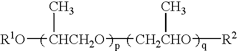
wherein R¹ and R² are each independently a hydrogen atom or alkyl group having 1 to 4 carbon atoms, and p and q are each independently an integer of 0 to 3, with the proviso that p+q=1 to 3, R¹ and R² cannot be a hydrogen atom at the same time, when one of R¹ and R² is a hydrogen atom, the other is an alkyl group having 3 or more carbon atoms, and when R¹ and R² are both a methyl group or ethyl group, p+q=2 to 3,
and the polar organic solvent having high compatibility with oil and high compatibility with water is a propylene glycol alkyl ether represented by the following formula (II): 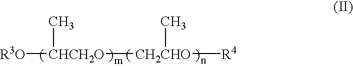
wherein R³ and R⁴ are each independently a hydrogen atom, methyl group or ethyl group, and m and n are each independently an integer of 0 to 3, with the proviso that R³ and R⁴ cannot be a hydrogen atom or ethyl group at the same time, when one of R³ and R⁴ is a hydrogen atom, m+n is 1 to 3 and when R³ and R⁴ are both a methyl group, m+n is 1,
or an imidazolidinone compound represented by the following formula (III): 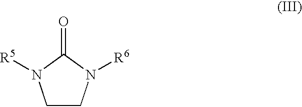
wherein R⁵ and R⁶ are each independently a methyl group or ethyl group.

5. The method of claim 1, wherein the first detergent is a mixture of an organic solvent having high compatibility with oil and low compatibility with water and a surfactant and the second detergent is a such that water and the same organic solvent and surfactant as the organic solvent and surfactant contained in the first detergent form a uniform emulsion phase.

6. The method of claim 5, wherein the ratio of the polar organic solvent having high compatibility with oil and low compatibility with water to the surfactant in the second detergent is substantially the same as that of the first detergent.

7. A multi-tank cleaning system comprising a pre-cleaning tank containing a first detergent which comprises at least one organic solvent having high compatibility with oil and a post-cleaning tank containing a second detergent in which water and at least one organic solvent identical to the at least one organic solvent contained in the first detergent form a homogeneousphase or emulsion phase, both tanks being directly connected to each other.
